(19) United States
(12) Patent Application Publication
(10) Pub. No.: US 2005/0247184 A1
(43) Pub. Date: Nov. 10, 2005

(54) Grip tip for vibrato bar

(76) Inventor: Sheldon D. Lavineway, Delta (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/123,029

(22) Filed: May 6, 2005

Related U.S. Application Data
(60) Provisional application No. 60/569,257, filed on May 10, 2004.

(51) Int. Cl. G10D 3/00

(52) U.S. Cl. 84/313

(57) ABSTRACT

A tip for a vibrato bar of a stringed instrument. The tip comprises an attachment member attached to the vibrato bar, a screw, and a compressible member. The attachment member has a threaded hole in an end thereof opposite the vibrato bar. The screw is threadably inserted into the threaded hole of the attachment member. The compressible member has an aperture therethrough, and is disposed between a head of the screw and the attachment member, with the screw inserted through the aperture. Tightening of the screw compresses the compressible member, thereby increasing the radius of the compressible member.

### TECHNICAL FIELD

The invention relates to vibrato devices for stringed instruments. In particular, the invention relates to a tip for a vibrato bar.

### BACKGROUND

It is sometimes desirable to provide a stringed instrument such as a guitar with means for allowing a musician to raise and lower the pitch of a note produced when the instrument is played with a given finger position. One such means is a vibrato bar. FIG. 1 illustrates a prior art example of a guitar 10 with a vibrato bar 20. Guitar 10 comprises a body 11, a neck 12, and a plurality of strings 13 (six strings are shown in the example illustrated in FIG. 1). Strings 13 are strung from bridge assembly 14 over nut 16 and attached to tuning posts 18. Vibrato bar 20 is coupled to bridge assembly 14 such that when bar 20 is in the position shown in FIG. 1, pulling vibrato bar 20 away from body 11 increases the tension on strings 13, thereby raising the pitch produced by strings 13. Likewise pushing vibrato bar 20 closer to body 11 decreases the tension on strings 13 and lowers the pitch.

Vibrato bar 20 is typically coupled to bridge assembly 14 by means of a pivotal attachment so that vibrato bar 20 may be pivoted out of the way as indicated by dotted line 20A when not in use. In the example illustrated in FIG. 1, vibrato bar 20 is simply screwed into a lower portion of bridge assembly 14. Vibrato bar 20 is usually constructed of metal, and may be provided with a plastic tip 22.

One problem that the inventor has noticed with prior art vibrato bars is that if the musician's hands are sweaty they can easily slip off of vibrato bar 20 or tip 22. Another problem is that it can be inconvenient to remove tip 22 if it becomes damaged or if a different sized tip is desired. Another problem is that it can be inconvenient to unscrew vibrato bar 20 from bridge assembly 14 in order to remove vibrato bar 20.

### SUMMARY OF THE INVENTION

The invention provides an improved tip for a vibrato bar of a stringed instrument. The tip comprises an attachment member, a screw and a compressible member with a radius that increases when the compressible member is compressed by tightening the screw. A washer may be disposed between the head of the screw and the compressible member. The compressible member preferably provides a comfortable, non-slip surface for supporting the musician's hand when operating the vibrato bar.

Further aspects of the invention and details of specific embodiments will become apparent from the following description.

### BRIEF DESCRIPTION OF THE DRAWINGS

In Figures which illustrate non-limiting embodiments of the invention:

FIG. 1 illustrates an example of a guitar with a vibrato bar according to the prior art;

FIG. 2 illustrates a vibrato bar according to one embodiment of the invention;

FIG. 3 is a sectional view along the line 3-3 of FIG. 2; and,

FIG. 4 shows the tip of FIG. 3 in a compressed position.

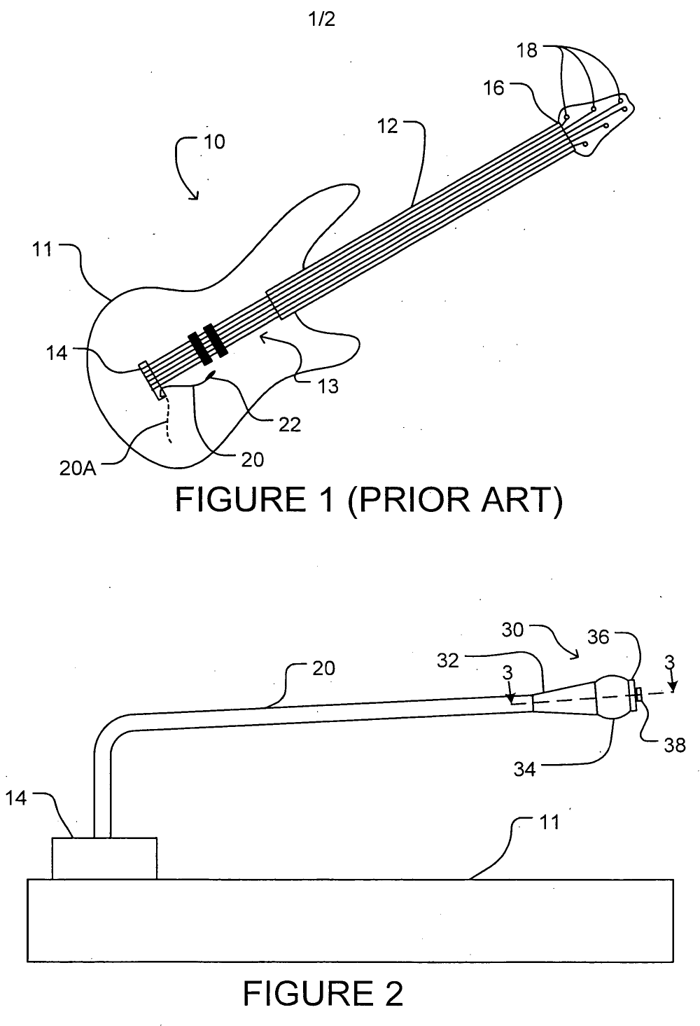

### DESCRIPTION

Throughout the following description, specific details are set forth in order to provide a more thorough understanding of the invention.

However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The invention provides an improved tip for a vibrato bar of a stringed instrument. The tip comprises an attachment member, a screw and a compressible member with a radius that increases when the compressible member is compressed by tightening the screw, so that a musician can adjust the size of the tip. A washer may be disposed between the head of the screw and the compressible member. The compressible member preferably provides a comfortable, non-slip surface for supporting the musician's hand when operating the vibrato bar.

FIGS. 2 to 4 show a vibrato bar 20 with an improved tip 30 according to one embodiment of the invention. Vibrato bar 20 may be coupled to bridge assembly by a press fit attachment mechanism to facilitate removal of vibrato bar 20 when not in use. Tip 30 comprises an attachment member 32, a compressible member 34, a washer 36 and a screw 38. Attachment member 32 may be screwed onto the end of vibrato bar 20, or may be attached thereto by any suitable means. In the illustrated embodiment, attachment member 32 has a frusto-conical shape, and compressible member 34 and washer 36 have a generally circular cross-section, but it is to be understood that the shape of attachment member 32, compressible member 34 and/or washer 36 could be varied for aesthetic or other reasons without departing from the spirit or scope of the invention.

Compressible member 34 has an aperture therethrough to accommodate screw 38. Screw 38 has a threaded portion 37 at one end and a head 39 at an opposite end. Attachment member 32 has a threaded hole 33 therein for receiving threaded portion 37 of screw 38. In the illustrated embodiment, washer 36 is disposed between head 39 and compressible member 34, but as will be understood by one skilled in the art, washer 36 may be omitted provided head 39 is large enough not to be inserted into the aperture in compressible member 34.

Compressible member 34 may be constructed from rubber, urethane, or any other suitable material. Compressible member 34 preferably provides a comfortable, non-slip surface for supporting the musician's hand when operating vibrato bar 20.

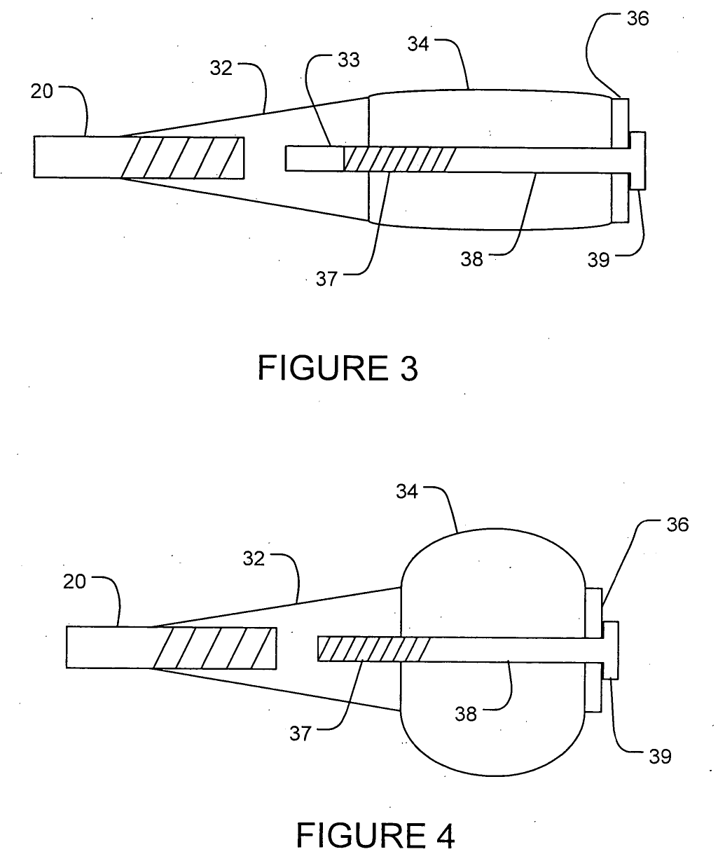

Compressible member 34 is deformable between a relaxed position, as shown in FIG. 3, and a compressed position, as shown in FIG. 4. As shown in FIG. 3, in the relaxed position, compressible member 34 has a radius slightly larger than that of attachment member 32. When screw 38 is tightened, head 39 moves toward attachment member 32 thereby compressing compressible member 34 and increasing its radius, until compressible member 34 is in the compressed position shown in FIG. 4. This arrangement allows for the continuous adjustment of the radius of compressible member 34 to suit the musician's individual preference.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. A tip for a vibrato bar of a stringed instrument, the tip comprising:
an attachment member attached to the vibrato bar, the attachment member having a threaded hole in an end thereof opposite the vibrato bar;
a screw threadably inserted into the threaded hole of the attachment member; and
a compressible member having an aperture therethrough, the compressible member disposed between a head of the screw and the attachment member with the screw inserted through the aperture, whereby tightening of the screw compresses the compressible member such that a radius of the compressible member increases.

2. A tip according to claim 1 comprising a washer disposed between the head of the screw and the compressible member.

3. A tip according to claim 1 wherein the attachment member has a frusto-conical shape.

4. A tip according to claim 1 wherein the compressible member has a generally circular cross-section.

5. A tip according to claim 2 wherein the compressible member and the washer both have a generally circular cross-section.
